(19) United States
(12) Patent Application Publication
(10) Pub. No.: US 2018/0045687 A1
(43) Pub. Date: Feb. 15, 2018

(54) DEFECT ANALYSIS DEVICE, DEFECT ANALYSIS SYSTEM, DEFECT ANALYSIS METHOD, AND COMPUTER READABLE RECORDING MEDIUM

(71) Applicant: NEC Corporation, Minato-ku, Tokyo (JP)

(72) Inventors: Shin TOMINAGA, Tokyo (JP); Masatake TAKAHASHI, Tokyo (JP); Kanta MIYAKE, Tokyo (JP)

(73) Assignee: NEC Corporation, Minato-ku, Tokyo (JP)

(21) Appl. No.: 15/557,535

(22) PCT Filed: Mar. 22, 2016
(86) PCT No.: PCT/JP2016/001638

§ 371 Date: Sep. 12, 2017

(30) Foreign Application Priority Data
Mar. 24, 2015 (JP) 2015-060443

(51) Int. Cl. G01N 29/34; G01M 3/02

(52) U.S. Cl. CPC G01N 29/348; G01M 3/02; G01N 2291/262

(57) ABSTRACT

To highly accurately determine whether there is a defect in a pipe.

A defect analysis device includes frequency determining means for determining a first frequency band based on a first vibration occurred at a first point located within a predetermined range from a deployment position of vibration detection means capable of detecting a vibration occurred at a pipe, determining a second frequency band based on a second vibration occurred at a second point located which is different from the first point, and determining a leakage frequency band based on the first frequency band and the second frequency band, and signal processing means for determining a defect between the first point and the second point based on a vibration level of the vibration in the leakage frequency band.

### TECHNICAL FIELD

The present invention relates to a defect analysis device, a defect analysis system, a defect analysis method, and a computer readable recording medium which analyze a defect.

### BACKGROUND ART

By virtue of progress of IT (Information Technology) and network technology which are based on digitization, an amount of information which a person and an electronic device handle and store is increasing steadily. Acquiring accurate data on a phenomenon from a sensor which is an input device, carrying out correct analysis, determination and processing to the data, and a person's recognizing the data to be useful information are assessed to be important for human society, which is becoming insensitive to a large amount of information because of its largeness, in order to establish a safe and secure society.

In modern life, facilities such as water and sewage networks, chemical high-pressure pipelines for gas, oil, and the like, high speed railways, long span bridges, skyscrapers, large passenger airplanes, and automobiles are constructed, and they form an infrastructure of affluent society. If the facilities are destroyed by unexpected natural disaster such as earthquakes or a lifetime deterioration and resulting in a serious accident, the impact on society is enormous and vast economic may occur. A member of the facility suffers from gradual deterioration such as corrosion, abrasion, or wobble depending on a usage time, and consequently reaches a malfunction such as destruction. In order to ensure safety and security of the facility, a great effort is made for technology development over scientific fields such as science, engineering, sociology, and the like. In particular, progress of non-destructive inspection technology, which is an inspection technology with a low cost and simple operation, plays an important role in prevention of serious accident caused by deterioration and destruction of the facility.

The acoustic sensory test, in which a person listens to a leakage sound, is generally used as an inspection on leakage of fluid caused by deterioration or destruction of pipe such as water and sewage network or pipeline. However, since the pipe is buried in the ground or is installed at a high place of the building in many cases, the inspection involves danger, and requires a plenty of labors. Therefore, it is difficult to achieve high accuracy and sufficient inspection. Moreover, since the acoustic sensory test depends on the skill of inspector, low detection accuracy is a factor of difficulty in prevention of the leakage accident.

When presence of leakage is revealed, it is required to identify a position of the leakage with high level precision because of necessity for reducing a repair cost. At present, the position is identified by the acoustic sensory test by the expert inspector. However, for example, external disturbance such as the traffic noise exists during the inspection, and when a frequency component of the external disturbance is similar to a frequency component of a sound caused by the leakage, there is a possibility that it becomes difficult to determine whether the leakage has occurred or not. Therefore, it is devised that measurement is carried out at a midnight time zone with a small amount of external disturbance, which may impose a severe burden on the inspector.

In order to solve the above-mentioned problem, a leakage inspection method using a machine is proposed.

PTL1 describes an example of the leakage inspection method using machine. In the method described in PTL1, a stick for detecting a vibration, upper end of which appears over a surface of the ground, is attached to a water pipe buried in the ground, and a leakage frequency is determined based on a change in spectrum which is generated when a water pressure changes. Then, a leakage point in the pipe is identified based on a vibration level of the leakage frequency and the arrangement of the stick.

### CITATION LIST

### Patent Literature

[PTL1] Japanese Patent Application Laid-Open Publication No. 2005-265663

### SUMMARY OF INVENTION

### Technical Problem

However, such leakage inspection methods using machine do not have sufficient accuracy in detecting the leakage.

In the method described in PTL 1, it is difficult to distinguish whether the factor contributing to the increase of the spectrum is the leakage or the external disturbance. Therefore, the method described in PTL 1 has an issue of a false determination of leakage presence when the leakage vibration is mixed with the external disturbance.

A main object of the present invention is to provide a defect analysis device, a defect analysis method, and a program which may solve the above-mentioned issue.

### Solution to Problem

A defect analysis device in an aspect of the present invention includes:

frequency determining means for determining a first frequency band based on a first vibration occurred at a first point located within a predetermined range from a deployment position of vibration detection means capable of detecting a vibration occurred at a pipe, determining a second frequency band based on a second vibration occurred at a second point which is located different from the first point, and determining a leakage frequency band based on the first frequency band and the second frequency band; and

signal processing means for determining a defect between the first point and the second point based on a vibration level of the vibration in the leakage frequency band.

A defect analysis method in an aspect of the present invention includes:

determining a first frequency band based on a first vibration occurred at a first point, the first point being located within a predetermined range from a point of detecting a vibration occurred in a pipe, determining a second frequency band based on a second vibration occurred at a second point, the second point being located different from the first point, and determining a leakage frequency band based on the first frequency band and the second frequency band; and

determining a defect between the first point and the second point based on a vibration level of the vibration in the leakage frequency band.

A computer readable recording medium according to the present invention non-transitorily stores a program causing a computer to execute:

a frequency determining process of determining a first frequency band based on a first vibration occurred at a first point, the first point being located in response to a point of detecting a vibration generated in a pipe, determining a second frequency band based on a second vibration occurred at a second point, the second point being located different from the first point, and determining a leakage frequency band based on the first frequency band and the second frequency band; and

a signal processing process of determining a defect between the first point and the second point based on a vibration level of the vibration in the leakage frequency band.

### Advantageous Effects of Invention

According to the present invention, whether there is a defect at a pipe or not may be accurately determined.

### BRIEF DESCRIPTION OF DRAWINGS

FIG. 1 is a diagram illustrating configuration of a defect analysis device and a defect analysis system in a first example embodiment of the present invention.

FIG. 2 (a) is a diagram illustrating an example of a frequency selection method of the defect analysis device in the first example embodiment of the present invention.

FIG. 2 (b) is a diagram illustrating an example of the frequency selection method of the defect analysis device in the first example embodiment of the present invention.

FIG. 2 (c) is a diagram illustrating an example of the frequency selection method of the defect analysis device in the first example embodiment of the present invention.

FIG. 3 is a flowchart illustrating an example of a flow of processes which are carried out by the defect analysis device in the first example embodiment of the present invention.

FIG. 4 is a diagram illustrating an example of configuration that a control device is installed in the defect analysis device in the first example embodiment of the present invention.

FIG. 5 is a diagram illustrating configuration of a defect analysis device and a defect analysis system in a second example embodiment of the present invention.

FIG. 6 is a diagram illustrating an example of configuration that a control device is installed in the defect analysis device in the second example embodiment of the present invention.

FIG. 7 is a diagram illustrating an example of an information processing device which implements the device or the like in each of the example embodiments of the present invention.

### DESCRIPTION OF EMBODIMENTS

Hereinafter, an example embodiment of the present invention will be described with reference to drawings.

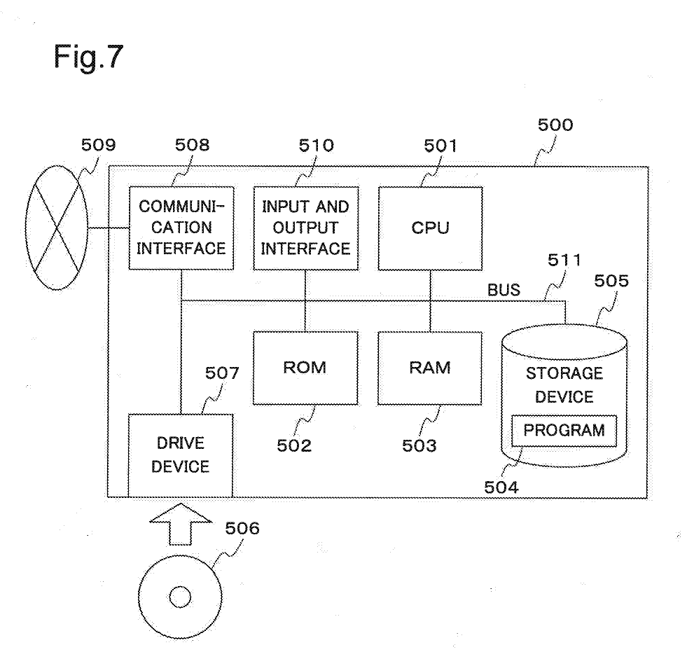

In each example embodiment of the present invention, each component of each device (system) indicate a block of a functional unit. A part or a whole of each component of each device (system) is implemented, for example, by any suitable combination of an information processing device 500 illustrated in FIG. 7 and a program. The information processing device 500 includes the following components as an example.
CPU (Central Processing Unit) 501
ROM (Read Only Memory) 502
RAM (Random Access Memory) 503
Program 504 which is loaded into the RAM 503
Storage unit 505 which stores the program 504
Drive device 507 which reads/writes from/to a storage medium 506 respectively
Communication interface 508 connected with a communication network 509
Input and output interface 510 for inputting and outputting data
Bus 511 connecting the respective components

Each component of each device in each example embodiment is implemented by the CPU 501 acquiring the program 504 which implements functions of each component, and executing the program. The program 504 which implements the functions of each component of each device is stored in, for example, the storage device 505 or the RAM 503 in advance, and is read out by the CPU 501 as needed. Here, the program 504 may be supplied to the CPU 501 via the communication network 509, or the program stored in the storage medium 506 in advance may be read out and supplied to the CPU 501 by the drive device 507.

There are various modifications of the method for implementing each device. For example, each device may be realized by implementing respective components using arbitrary different combinations of the information processing device 500 and programs. Alternatively, a plurality of components of each device may be implemented by any combination of one information processing device 500 and a program.

There are various modifications of the method for implementing each device. For example, each device may be realized by implementing respective components using arbitrary different combinations of the information processing device 500 and programs. Alternatively, a plurality of components of each device may be implemented by any combination of one information processing device 500 and a program.

Moreover, a part of or a whole of each component of each device is implemented by a general purpose or dedicated circuit (circuitry), a processor or the like, or a combination thereof. A part or a whole of each component of each device may be implemented by using a single chip, or may be implemented by using a plurality of chips connected each other via a bus. A part or a whole of each component of each device may be implemented by a combination of the circuitry or the like and the program.

When a part or a whole of each component of each device is implemented by a plurality of the information processing devices, the circuitries or the like, the plurality of the information processing devices, the plurality of the circuitries or other devices may be centralized or distributed. For example, the information processing devices, the circuitries, other devices may be implemented in a configuration that the information processing devices, the circuitries or the like are connected each other via the communication network.

### First Example Embodiment

Firstly, an overview of a defect analysis device in a first example embodiment will be described. The defect analysis device and a defect analysis system in the present example embodiment determines presence or absence of a defect, which is formed in a pipe installed at a position apart from a surface of the ground (for example, in the ground) by using a vibration sensor deployed on the pipe, or a connection unit such as a stop cock or a fire hydrant which is connected to the pipe.

When there is the defect in the pipe, a vibration caused by fluid leakage from the defect is propagating through the pipe or fluid flowing in the pipe, and reaches the vibration sensor. The defect analysis device in the present example embodiment determines the presence of the defect by using the vibration sensor when a vibration level in a predetermined frequency band, which is caused by a leak toward an external part of the pipe from the defect, exceeds a predetermined threshold value. The predetermined frequency band is a frequency band where a vibration caused by leakage of the fluid is dominant. The vibration level represents the magnitude of the vibration. For example, the vibration level is vibration acceleration.

With respect to the vibration, which is propagating through the pipe or the fluid flowing in the pipe, its attenuation with distance changes depending on a frequency band of the vibration. Then, as a method of selecting the predetermined frequency band, a method of approximately calculating the predetermined frequency band based on materials or other characteristics of a propagation path, or a method of selecting the predetermined frequency band by detecting vibration of the pipe or the fluid flowing in the pipe in a state that there is no leakage in advance, and acquiring frequency characteristics, can be used. According to these methods, the presence of the defect can be determined by the frequency band, at which the vibration caused by leakage when the leakage occurs reaches sufficiently far position.

However, according to the method of approximately calculating the predetermined frequency band, it is possible to select the predetermined wide frequency band, while it is difficult to select a narrower frequency band for further investigation in detail. Moreover, when a vibration from a point away from the vibration sensor (cross-response) is detected as another method, there is a case that a noise strongly reflecting a vibration response (auto-response) occurred close to a deployment position of the vibration sensor overlaps with the cross-response which should originally be detected. It is conceivable that causes of the noise include an external disturbance which occurs close to the vibration sensor, multiple reflection of a vibration which reaches the deployment position of the vibration sensor, or other causes. As a result, the frequency band suitable for the defect analysis may not be obtained.

Thus, the defect analysis system in the present example embodiment not only detects vibration from one point which is away from the vibration sensor, but also independently detects vibration which occurs close to the deployment position of the vibration sensor and thereby selects the frequency band to be used for the defect analysis by complementarily using the cross-response and the auto-response. Further, the defect analysis system analyzes the defect by using the vibration in the selected frequency band. By selecting and using the frequency band as described above, accuracy is improved in detecting the vibration caused by leakage of the fluid from the defect. In addition, the accuracy in detecting the vibration is further improved by also using the frequency band which is approximately calculated based on materials of the pipe or the like in advance, when selecting the frequency band as described above.

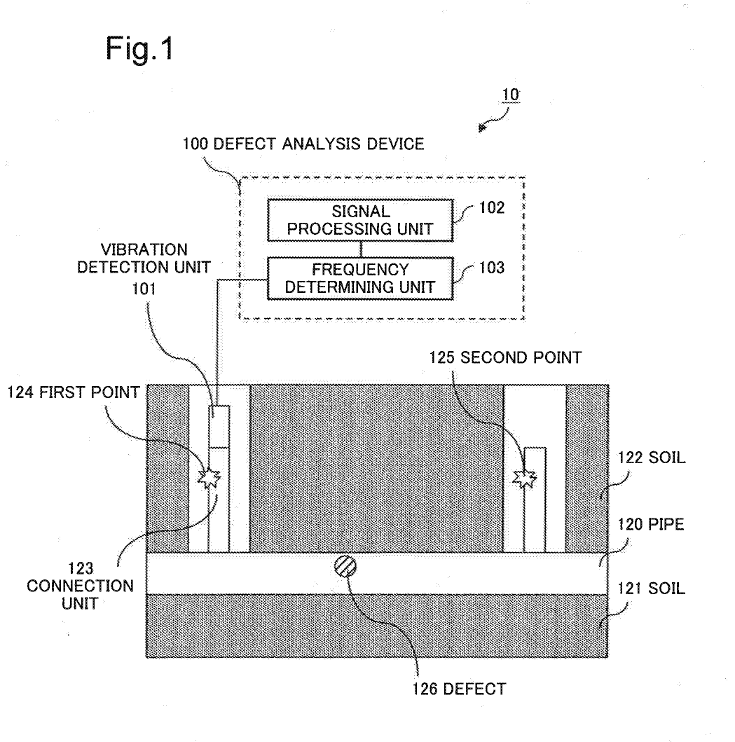

Next, a configuration of the defect analysis system in the present example embodiment will be described in detail with reference to the drawings. FIG. 1 illustrates a configuration of a defect analysis device 100 and a defect analysis system 10 in the first example embodiment of the present invention. The defect analysis device 100 in the present example embodiment illustrated in FIG. 1 determines, for example, presence of a defect 126 formed at a pipe 120. The defect 126 is, for example, a leakage hole which is caused in the pipe 120.

The pipe 120 illustrated in FIG. 1 is installed in the ground, which is interposed between soil 121 and soil 122. Fluid flows in the pipe 120. The fluid may be a liquid such as water or the like, or a gaseous matter such as air, gas or the like corresponds to the fluid. The pipe 120 may be installed in a garret or underground of a building, or may be embedded in a wall, a pillar or the like.

The defect analysis system 10 includes the defect analysis device 100 and a vibration detection unit 101. The defect analysis device 100 includes a signal processing unit 102 and a frequency determining unit 103. Firstly, a relation among positions of the above-described components will be described.

The vibration detection unit 101 detects a vibration propagating through the pipe 120 or the fluid. The vibration detection unit 101 is deployed at a position where the vibration can be detected. For example, the vibration detection unit 101 may be deployed so as to be directly attached to an inner surface or an outer surface of the pipe 120, or may be deployed on a connection unit 123 (flange, fire hydrant plug or the like) of the pipe 120. In the case of the example illustrated in FIG. 1, the vibration detection unit 101 is deployed on the connection unit 123 which is arranged in a manhole. A plurality of the vibration detection units 101 may be provided. For example, at least one of the plurality of the vibration detection units 101 may be deployed, for example, at positions where the vibration propagating through the pipe 12 or the fluid close to a second point can be detected. Since the defect analysis system 10 includes the plurality of the vibration detection units 101, it is possible not only to determine presence of the defect, but also to identify a position of the defect, by using vibration data detected by the plurality of the vibration detection units 101. For example, when the two vibration detection units 101 are provided, the position where the defect occurs is identified based on a time difference Δt representing a difference between when the respective vibration detection units 101 detect the vibration occurred at the defect, a distance L between two vibration detection units 101, and a sound speed v of the vibration. In other words, a distance from one of two vibration detection units to the position of the defect is calculated by using the following Formula (L−vΔt)/2. Furthermore, when a vibration attenuation rate with a distance is calculated in advance, it is possible to determine the position of the defect based on levels of the vibrations which the two vibration detection units 101 respectively detect.

In the present example embodiment, when determining leakage of the fluid, the vibration detection unit 101 detects a vibration occurred at a first point 124 such as a wall surface of the connection unit 123 (a first vibration), and a vibration occurred at a second point 125 (a second vibration). Here, the first point is set, for example, at a point located within a predetermined range from the deployment position of the vibration detection unit 101 (for example, a point close to the deployment position of the vibration detection unit 101). The first point is a point within almost 1 m from the deployment position of the vibration detection unit 101, and typically, it is preferable that the point is located in an area of 5 cm to 50 cm inclusive from the deployment position of the vibration detection unit 101. Here, while a means for generating the first vibration and the second vibration is not particularly specified, it can be exemplified, for example, that the traffic noise generated by a person, a bicycle, an automobile or the like, shakes the pipe or the connection unit through soil or a wall surface of a manhole, and thereby indirectly applies a vibration to the first point or the second point. Moreover, as the simplest means, it can be exemplified that a vibration detected when a person hits the first point with a hammer or the like is considered as the vibration from the first point, and a vibration detected when the person hits the second point with the hammer is considered as the vibration from the second point.

The vibration detection unit 101 detects vibrations generated by various vibration sources. When the first point is set within the above-described range, the vibration from the first point becomes dominant, namely, several hundred times greater than other vibration components or more in the vibration detected by the vibration detection unit 101. In other words, the first point may be set to be within a range in such a way that the vibration from the first point may become dominant in comparison with other vibrations when the vibration detection unit 101 detects the vibration. It is preferable that the second point is far from the installation point of the vibration detection unit 101 by a distance of almost 1 m to 10 km inclusive, and typically by a distance of 50 m to 500 m inclusive.

Location of the defect analysis device 100 is not particularly limited, and the defect analysis device 100 can be installed at any position as far as it can communicate with the vibration detection unit 101. The defect analysis device 100 may be located on the ground, or in the ground. For example, the defect analysis device 100 may be located on the ground, and communicate with the vibration detection unit 101 through wired and/or wireless communication.

Next, configuration of each unit will be described in detail. The vibration detection unit 101 detects the second vibration (cross-response) that is at least one of vibrations that have occurred at the second point 125, the vibrations including a vibration propagating through the pipe 120, a vibration propagating through the fluid, and a vibration propagating through the connection unit 123. The vibration detection unit 101 further detects the first vibration (auto-response) that is at least one of vibrations that have occurred at the first point 124, the vibrations including a vibration propagating through the pipe 120, a vibration propagating through the fluid, and a vibration propagating through the connection unit 123.

The vibration detection unit 101 is implemented by using devices such as a piezoelectric type vibration sensor, an electromagnetic type vibration sensor, an ultrasonic sensor, a microphone, and other devices. As a detected signal, an electrical signal corresponding to, for example, an amplitude or a frequency of the vibration detected by the vibration detection unit 101, or the like is inputted into the signal processing unit 102 or the frequency determining unit 103.

The frequency determining unit 103 selects a frequency band, corresponding to the fluid leakage at defect analysis, by using vibration waveform of cross-response and vibration waveform of auto-response. In this manner, it is possible to appropriately select the frequency band of the vibration caused by the fluid leakage from the defect propagating through the pipe 120 or the fluid. Hereinafter, the reason will be described.

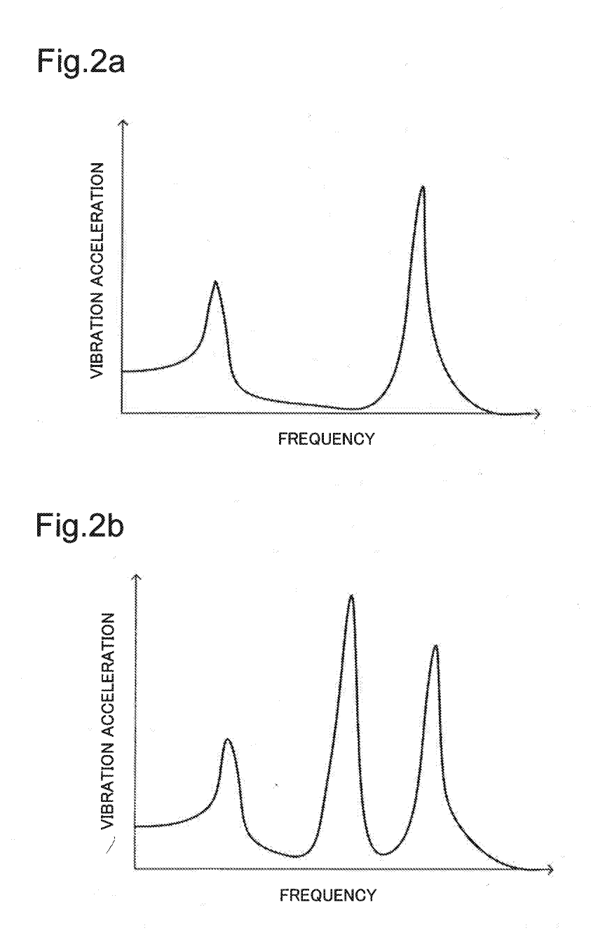

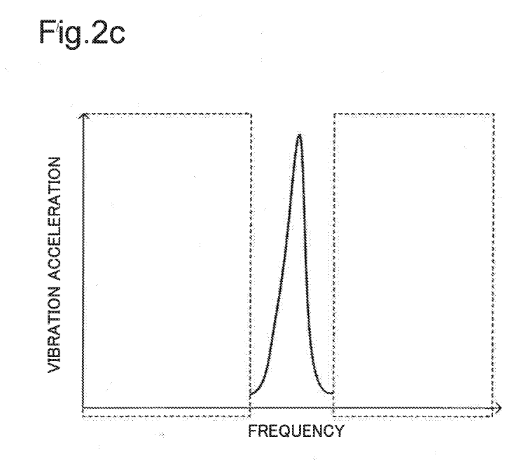

Each of FIGS. 2 (a) to (c) is a diagram illustrating an example of a frequency selection method of the defect analysis method in the present example embodiment. The vibration detection unit 101 detects the first vibration of the auto-response including a peak of vibration acceleration at a specific frequency band, as illustrated in FIG. 2 (a). Similarly, as illustrated in FIG. 2 (b), the vibration detection unit 101 detects the second vibration of the cross-response having a shape different from the shape illustrated in FIG. 2 (a). Then, the frequency determining unit 103 determines a first frequency band, including the peak of the vibration acceleration of the first vibration, based on the first vibration. The first frequency band is, for example, a frequency band falling within a predetermined range that extends from a frequency at the peak of the vibration acceleration of the first vibration. Moreover, the frequency determining unit 103 determines a second frequency band including the peak of the vibration acceleration of the second vibration, based on the second vibration. The second frequency band is, for example, a frequency band falling within a predetermined range that extends from a frequency at the peak of the vibration acceleration of the second vibration. Then, the frequency determining unit 103 determines a leakage frequency band, which is a frequency band used at defect analysis, based on the first frequency band and the second frequency band. As illustrated in FIG. 2 (c), the frequency determining unit 103 determines a range which excludes the first frequency band including the frequency peak in the auto-response illustrated in FIG. 2 (a), out of the second frequency band including the frequency peak in the cross-response illustrated in FIG. 2 (b), as the leakage frequency band.

The number of the first frequency bands or the number of the second frequency bands is not always limited to one. For example, a point at which the vibration acceleration has a local-maximum value is selected as the peak of the vibration acceleration. The first frequency band or the second frequency band may be set to be a frequency band which is higher than or equal to a predetermined threshold value.

By excluding influence of the auto-response from the cross-response according to the above-described processes, an appropriate frequency band to be used for the defect analysis can be selected. a frequency range (third frequency band), which is used as the leakage frequency band, may be approximately calculated based on physical information indicating materials (physical properties) of the propagation path of the vibration or the like, before excluding the auto-response from the cross-response. In this case, the frequency determining unit 103 carries out multi-stage process to exclude the frequency peak in the auto-response after deriving the third frequency band. A result of approximately calculating the frequency range is typically 1 Hz to 2 kHz in the case of a metal pipe, and 1 Hz and to 500 Hz in the case of a plastic pipe. However, the frequency range is not limited to the above-described ranges. By carrying out the multi-stage process as described above, the frequency determining unit 103 can select the frequency band associated with the leakage with high accuracy, in comparison with a case that only exclusion of the auto-response from the cross response is carried out. Accordingly, the defect analysis device 100 can determine presence of the defect with high accuracy.

The signal processing unit 102 then determines presence or absence of the fluid leakage from the pipe, based on a level of the vibration in the leakage frequency band determined as described above. For example, when the level of the vibration in the leakage frequency band exceeds a predetermined threshold value, the signal processing unit 102 determines presence of the fluid leakage from the pipe.

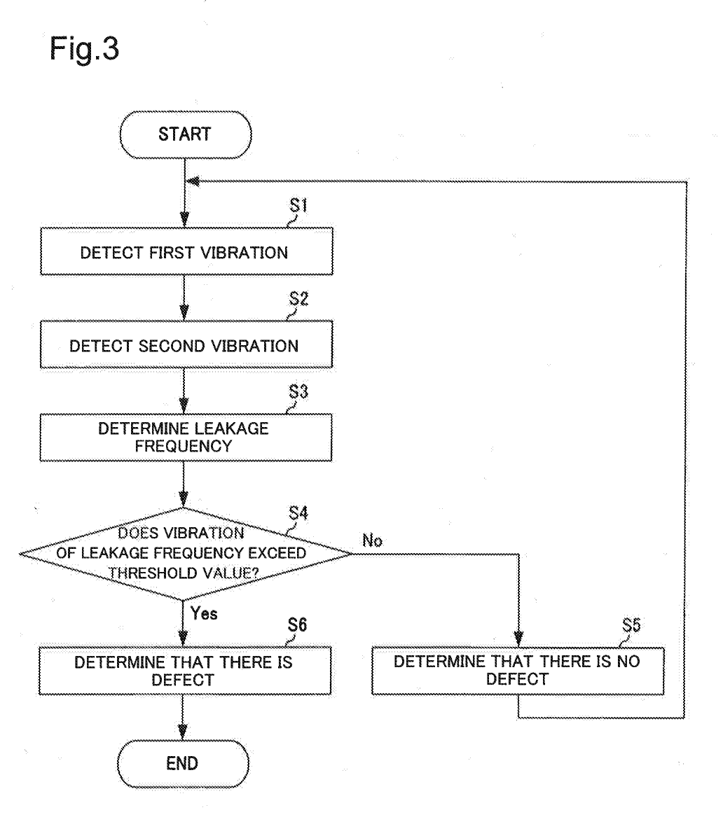

Next, a defect analysis method implemented by using the defect analysis device in the present example embodiment will be described. FIG. 3 is a flowchart illustrating an example of a flow of processes of the defect analysis method in the present example embodiment.

In Step S1, the vibration detection unit 101 detects the first vibration that is at least one of vibrations that have occurred at the first point 124, the vibrations including a vibration propagating through the pipe 120, a vibration propagating through the fluid, and a vibration propagating through the connection unit 123. Then, the vibration detection unit 101 transmits a detection signal to the frequency determining unit 103.

In Step S2, the vibration detection unit 101 detects the second vibration that is at least one of vibrations that have occurred at the second point 125, the vibrations including a vibration propagating through the pipe 120, a vibration propagating through the fluid, and a vibration propagating through the connection unit 123. Then, the vibration detection unit 101 transmits a detection signal to the frequency determining unit 103. In Step S1 and S2, an order of acquiring the vibrations can be reversed or the vibrations can be acquired simultaneously. That is, it is possible to adopt configuration that the first vibration is detected after the second vibration is detected.

Then, the frequency determining unit 103 determines the leakage frequency band used for the defect analysis, based on waveform of the first vibration and waveform of the second vibration both of which are detected by the vibration detection unit 101 (Step S3). The details have been described above.

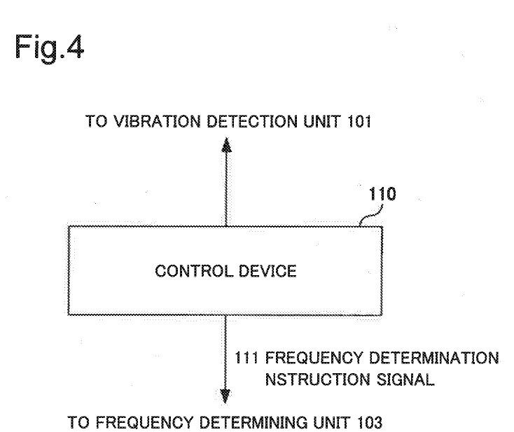

FIG. 4 is a diagram illustrating an example of a configuration that a control unit 110 is included in the defect analysis device 100. As illustrated in FIG. 4, the defect analysis device 100 further includes the control unit 110. Frequency data, stored in the control device 110 and approximately calculated based on the material (properties of the material) or the like, are inputted into the frequency determining unit 103 as a frequency determination instruction signal 111, and are used when determining the leakage frequency band, etc.

The second vibration may be successively acquired (measured) at timing (for example, the same day or the same time) when the first vibration is acquired (measured), and be inputted into the frequency determining unit 103. Alternatively, the second vibration may be acquired (measured) before the first vibration is acquired (measured), and may be stored in advance in the frequency determining unit 103. Further, the first vibration may be acquired (measured) before the second vibration is acquired (measured), and may be stored in the frequency determining unit 103 in advance.

Next, the signal processing unit 102 determines whether the vibration level (vibration acceleration) in the leakage frequency band exceeds a preset threshold value or not (Step S4). When the vibration level in the leakage frequency band does not exceed the preset threshold value, the signal processing unit 102 determines that there is no defect (leakage) (Step S5), and then the process of Step S1 is carried out. On the other hand, when the vibration level in the leakage frequency band exceeds the preset threshold value, the signal processing unit 102 determines that there is the defect (leakage) (Step S6).

As described above, in the present example embodiment, the vibration detection unit 101 detects the respective vibrations occurred at two points. Then, the frequency determining unit 103 of the defect analysis device 100 determines the leakage frequency band based on the vibration levels of the respective vibrations, and the signal processing unit 102 determines presence or absence of the defect based on the vibration level in the leakage frequency band. Since the defect analysis device 100 determines presence or absence of the defect based on the vibration level or the like in the leakage frequency band, which is determined as described above and is suitable frequency band for the defect analysis, the defect analysis device 100 can determine the presence or absence of the defect with high accuracy.

### Second Example Embodiment

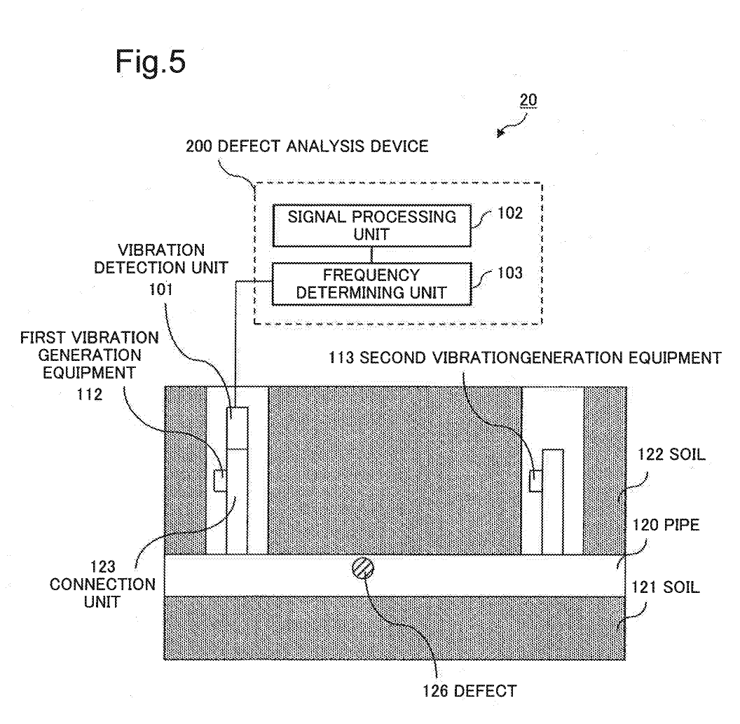

Next, a second example embodiment of the present invention will be described. FIG. 5 is a diagram illustrating the second example embodiment of the defect analysis device of the present invention. A defect analysis system 20 in the second example embodiment further includes a first vibration generation device 112 and a second vibration generation device 113, in addition to the elements of the defect analysis system 10 in the first example embodiment.

The first vibration generation device 112 is deployed at a position where a vibration can be applied to the pipe 120 or the fluid. For example, the first vibration generation device 112 may be deployed so as to be directly attached to an outer surface or an inner surface of the pipe 120, or may be deployed on the connection unit 123 (flange, fire hydrant plug, etc.) of the pipe 120. In a configuration illustrated in FIG. 5, the first vibration generation device 112 is installed at a position on the connection unit 123 arranged within a manhole, which is the position of the first point 124 in the first example embodiment.

The second vibration generation device 113 is deployed at a position where a vibration can be applied to the pipe 120 or the fluid. For example, the second vibration generation device 113 may be deployed so as to be directly attached to an outer surface or an inner surface of the pipe 120, or may be deployed on a connection unit 123 (flange, fire hydrant plug, etc.) of the pipe 120. In the configuration illustrated in FIG. 5, the second vibration generation device 113 is deployed at a position on the connection unit 123 arranged within a manhole, which is the position of the first point 125 in the first example embodiment.

The first vibration generation device 112 can apply a vibration including a plurality of frequencies (wide band frequency) to the first point 124 such as the wall surface of the connection unit 123. A means to apply the vibration including the plurality of frequencies is not particularly limited. The first vibration generation device 112 may simultaneously apply vibrations of the plurality of frequencies, or may sequentially apply the vibrations of the plurality of frequencies while changing the frequency. The first vibration generation device 112 may apply, for example, impulsive vibration or white noise.

The first vibration generation equipment 112 is implemented by an electromagnetic vibration generator, a permanent magnetic vibration generator, an electromagnetic speaker, an ultrasonic vibrator, or other equipment. If the first vibration generation device 112 can apply vibration to the fluid or the pipe 120, and can change the vibration frequency, or generate the vibration including a plurality of frequency components, the first vibration generation device 112 may be a device different from the above-described device.

The second vibration generation device 113 can apply the vibration including a plurality of frequencies (wide band frequency) to the second point 125 such as the wall surface of the connection unit 123. A means to apply the vibration including the plurality of frequencies is not particularly limited. The second vibration generation device 113 may simultaneously apply the vibrations of the plurality of frequencies, or may sequentially apply the vibrations of the plurality of frequencies while changing the frequency. The second vibration generation device 113 may apply, for example, impulsive vibration or white noise.

The second vibration generation device 113 is implemented by the electromagnetic vibration generator, the permanent magnetic vibration generator, the electromagnetic type speaker, the ultrasonic vibrator, or other equipment. If the second vibration generation device 113 can apply vibration to the fluid or the pipe 120, and can change the vibration frequency, or generate the vibration including a plurality of frequency components, the second vibration generation device 113 may be a device different from the above-described device.

In the configuration illustrated in FIG. 5, two vibration generation equipment, that is, the first vibration generation equipment 112 and the second vibration generation device 113 are deployed. However, in the present example embodiment, only one of the first vibration generation device 112 and the second vibration generation equipment 113 may be deployed.

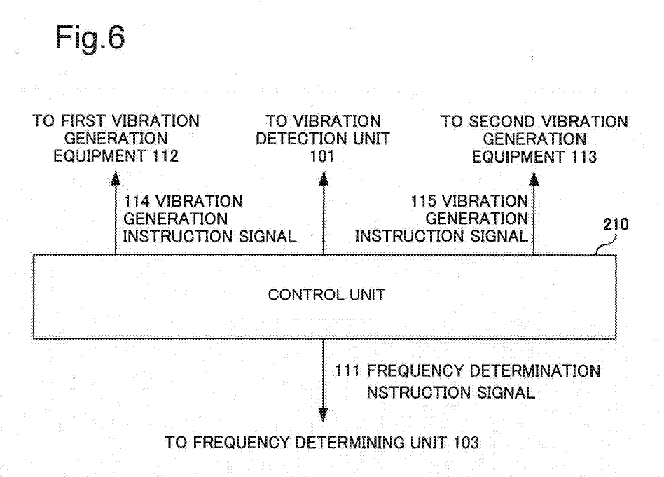

FIG. 6 is a diagram illustrating an example of a configuration that a control unit 210 is included in a defect analysis device 200. As illustrated in FIG. 6, the defect analysis device 200 may further include the control unit 210. In this case, the first vibration generation device 112 may apply vibration according to a vibration generation instruction signal 114 issued by the control unit 210, and the second vibration generation device 113 may apply vibration according to a vibration generation instruction signal 115 issued by the control unit 210.

In the present example embodiment, the defect analysis device 200 or the defect analysis system 20 acquires a frequency caused by the leakage by actively applying a vibration, and consequently can perform more precise defect analysis.

While the present invention has been described with reference to the example embodiments, the present invention is not limited to the above-described example embodiments. Various modifications which can be understood by those skilled in the art can be made to the configurations and details of the invention of the present application within the scope of the invention of the present application.

This application is based upon and claims the benefit of priority from Japanese Patent Application No. 2015-60443, filed on Mar. 24, 2015, the disclosure of which is incorporated herein in its entirety by reference.

### REFERENCE SIGNS LIST

10, 20 defect analysis system
100, 200 defect analysis device
101 vibration detection unit
102 signal processing unit
103 frequency determining unit
110, 210 control device
111 frequency determination instruction signal
112 first vibration generation device
113 second vibration generation device
114, 115 vibration generation instruction signal
120 pipe
121, 122 soil
123 connection unit
124 first point
125 second point
126 defect

What is claimed is:

1. A defect analysis device, comprising:
at least one processing component configured to:
determine a first frequency band based on a first vibration occurred at a first point located within a predetermined range from a deployment position of a vibration detector capable of detecting a vibration occurred at a pipe, determine a second frequency band based on a second vibration occurred at a second point which is located different from the first point, and determine a leakage frequency band based on the first frequency band and the second frequency band; and
determine a defect between the first point and the second point based on a vibration level of the vibration in the leakage frequency band.

2. The defect analysis device according to claim 1, the at least one processing component further configured to:
determine a third frequency band based on a physical property of the pipe or the fluid, and determine the leakage frequency band within a range of the third frequency band.

3. The defect analysis device according to claim 1, the at least one processing component further configured to:
determine the first frequency band based on a frequency at a peak of the first vibration.

4. The defect analysis device according to claim 1, the at least one processing component further configured to:
determine the second frequency band based on a frequency at a peak of the second vibration.

5. A defect analysis system, comprising:
the defect analysis device according to claim 1; and
the vibration detector configured to detect a vibration propagating through at least one of the pipe and fluid flowing in the pipe, the vibration detector being deployed on a pipe or a connection unit connected with the pipe.

6. The defect analysis system according to claim 5, further comprising:
a vibration generator configured to apply a vibration to at least one of the first point and the second point.

7. The defect analysis device according to claim 6, wherein
the vibration generator applies an impulsive vibration.

8. The defect analysis system according to claim 5, further comprising:
a plurality of the vibration detector.

9. A defect analysis method, comprising:
determining a first frequency band based on a first vibration occurred at a first point, the first point being located within a predetermined range from a point of detecting a vibration occurred in a pipe, determining a second frequency band based on a second vibration occurred at a second point, the second point being located different from the first point, and determining a leakage frequency band based on the first frequency band and the second frequency band; and
determining a defect between the first point and the second point based on a vibration level of the vibration in the leakage frequency band.

10. A computer readable recording medium storing a program causing a computer to execute:
a frequency determining process of determining a first frequency band based on a first vibration occurred at a first point, the first point being located in response to a point of detecting a vibration generated in a pipe, determining a second frequency band based on a second vibration occurred at a second point, the second point being located different from the first point, and determining a leakage frequency band based on the first frequency band and the second frequency band; and
a signal processing process of determining a defect between the first point and the second point based on a vibration level of the vibration in the leakage frequency band.
